(19) United States
(12) Patent Application Publication
(10) Pub. No.: US 2022/0144259 A1
(43) Pub. Date: May 12, 2022

(54) METHOD AND CONTROL DEVICE FOR VEHICLE COLLISION PREVENTION

(71) Applicant: ZF Friedrichshafen AG, Friedrichshafen (DE)

(72) Inventor: Marcus Hiemer, Meckenbeuren (DE)

(21) Appl. No.: 17/430,728

(22) PCT Filed: Jan. 21, 2020
(86) PCT No.: PCT/EP2020/051322

§ 371 Date: Aug. 13, 2021

(30) Foreign Application Priority Data
Feb. 15, 2019 (DE) 10 2019 202 026.7

(51) Int. Cl. B60W 30/095; B60W 30/09; B60W 50/00; B60W 50/16

(52) U.S. Cl. CPC B60W 30/0953; B60W 30/09; B60W 2050/143; B60W 50/16; B60W 50/0097

(57) ABSTRACT

A method for avoiding a collision of a vehicle with a potential collision object includes defining a safety zone around the potential collision object. The safety zone is located outside a danger zone around the vehicle. The method further includes predicting a trajectory corridor which is covered by the vehicle along a future trajectory and during a certain time period and performing a safety measure on the vehicle in order to avoid a collision of the vehicle with the potential collision object. The safety measure is performed as a function of a geometric comparison of the predicted trajectory corridor with the defined safety zone.

### CROSS REFERENCE TO RELATED APPLICATIONS

This application is a U.S. National Phase application under 35 U.S.C. § 371 of International Application No. PCT/EP2020/051322, filed on Jan. 21, 2020, and claims benefit to German Patent Application No. DE 10 2019 202 026.7, filed on Feb. 15, 2019. The International Application was published in German on Aug. 20, 2020 as WO 2020/164867 A1 under PCT Article 21(2).

### FIELD

The present disclosure relates to a method for the avoidance of a collision of a vehicle with an object. In addition, the present disclosure relates to a control device which is configured to carry out such a method and to a vehicle with such a control device.

### BACKGROUND

With a sensor system provided on a vehicle, objects located in the region surrounding the vehicle can be detected. According to US 2018/0170369 A1, an object in the environment of a vehicle with articulated steering is detected and an angle of articulation of the vehicle is restricted in order to avoid a collision.

### SUMMARY

In an embodiment, the present disclosure provides a method for avoiding a collision of a vehicle with a potential collision object. The method includes defining a safety zone around the potential collision object. The safety zone is located outside a danger zone around the vehicle. The method further includes predicting a trajectory corridor which is covered by the vehicle along a future trajectory and during a certain time period and performing a safety measure on the vehicle in order to avoid a collision of the vehicle with the potential collision object. The safety measure is performed as a function of a geometric comparison of the predicted trajectory corridor with the defined safety zone.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a vehicle having a control device according to one embodiment for explaining a method for collision avoidance;

FIG. 2 shows the vehicle from FIG. 1 to further explain the method for collision avoidance;

FIG. 3 shows another vehicle according to an embodiment to further explain the method for collision avoidance;

FIG. 4 shows the vehicle from FIG. 3 to further explain the method for collision avoidance; and

FIG. 5 shows a diagram with steps of the method for avoiding collision of a vehicle with a potential collision object according to one embodiment.

### DETAILED DESCRIPTION

The present disclosure relates to a method for the avoidance of a collision of a vehicle with a potential collision object. In principle, the vehicle can be any non-rail-bound vehicle. The vehicle can be designed as a vehicle that can be operated at least predominantly away from the road network or as a so-called “off-highway” vehicle, or also as a road vehicle. It may furthermore be an articulated vehicle or an articulated-joint vehicle. The vehicle may have a trailer. For example, such a vehicle with trailer may be designed as a vehicle combination, road train, or tractor trailer. The vehicle combination may, for example, be an agricultural machine with a trailer. The vehicle may be a dump truck, tractor, truck, bus or passenger vehicle.

In principle, the potential collision object may be any object which can be located in the region surrounding the vehicle and which can possibly collide with the vehicle, i.e. crash. The potential collision object can, for example, be another vehicle, a person or an object. In the event of a potential collision, the vehicle, person or object can damage itself and/or cause damage to the vehicle. In the event of a potential collision, the collision object and the vehicle may move toward each other and collide. In the potential collision, the potential collision object may also be motionless, wherein the vehicle then hits the motionless potential collision object. In the potential collision, the vehicle may also be motionless, wherein the potential collision object then hits the motionless vehicle. In other words, there is an impending collision if the relative distance between the potential collision object and the vehicle is reduced such that it is practically zero.

As one step, the method comprises defining a safety zone around the potential collision object. The safety zone can be defined as a function of the potential collision object that is recognized or detected by the vehicle on the basis of the sensor. In other words, the safety zone may only be established when a potential collision object has been detected. For this purpose, the potential collision object can be recognized or detected with an environment detection sensor system arranged on the vehicle. The safety zone can be defined in a region surrounding the potential collision object. The vehicle is located outside the safety zone of the potential collision object. In other words, the safety zone can define a safe zone in which the collision object can move safely without a current threat of collision with the vehicle.

According to the method, the safety zone of the collision object is also outside a danger zone around the vehicle. The two zones thus define zones that are geographically separated from one another. Therefore, the safety zone of the collision object and the danger zone of the vehicle cannot overlap. However, the safety zone of the collision object may border on the danger zone of the vehicle at least in sections. The danger zone can be understood to be a zone in which a current danger for a potential collision object can emanate from the vehicle. The danger zone may be defined as a function of the current position of the vehicle or of vehicle parts, for example a trailer or a work tool, in the region surrounding the vehicle.

As a further step, the method comprises predicting a trajectory corridor which is covered by the vehicle along a future trajectory and during a certain time period. Predicting a trajectory corridor may include predicting a future trajectory corridor. The predicting of the trajectory corridor may also comprise a calculation or mathematical estimation of a future trajectory corridor. A trajectory corridor can thus be predicted with a certain probability. A trajectory corridor can be predicted, for example, based on an extrapolation of a previous trajectory of the vehicle. For example, a higher order polynomial, for example a second or third order polynomial, can thus jointly describe the previous vehicle trajectory and a section of a future vehicle trajectory. The future trajectory corridor can then be defined on the basis of an extrapolated vehicle trajectory.

The trajectory corridor may be a corridor of a tractrix curve of the vehicle which is driven over or covered by the vehicle whilst driving in a straight line and/or around bends. In other words, the trajectory corridor may be a space or driving region dynamically occupied by the vehicle along its future trajectory. The trajectory corridor may also be referred to as a drag corridor of the vehicle. When the vehicle is cornering to the outside of the curve, the trajectory corridor can be limited by a movement curve of an outside vehicle region. The outside vehicle region may, for example, be an outside front region or side region of the vehicle. During a cornering of the vehicle, the trajectory corridor may also be limited to the inside of the curve by a movement curve of an inside vehicle part. The inside vehicle region may, for example, be an inside wheel of the vehicle or an inside trailer wheel. The time period of the predicted trajectory corridor may have a prediction interval which defines the future timeframe in which the trajectory corridor is predicted. The time period can be determined, for example, as a function of or based on a reaction time of the vehicle to a detected potential collision object, a braking time of the vehicle in order to avoid a collision with the potential collision object and/or a current vehicle speed.

As a further step, the method comprises performing a safety measure on the vehicle in order to avoid a collision of the vehicle with the potential collision object. The safety measure may be a reaction to a potential collision object detected by the vehicle in order to avoid an imminent collision. The reaction may be an active reaction performed by the vehicle itself or by an operator of the vehicle, for example an intervention in the dynamics of the vehicle. The safety measure may thus be an active change in the movement behavior of the vehicle or the automatic selection of a new driving route. Alternatively or additionally, the reaction may be an issuance of a warning to warn of the potential collision. The operator of the vehicle can then decide himself which measure is required to avoid a collision.

According to the method, the performance of the safety measure is based on a geometric comparison of the predicted trajectory corridor or its spatial position with the defined safety zone or its spatial position. The performance of the safety measure may then become necessary if the predicted trajectory corridor extends too close towards the safety zone. In other words, the geometric comparison may comprise a determination of a distance between the safety zone and the trajectory corridor. Alternatively or additionally, the performance of the safety measure may then become necessary when the predicted trajectory corridor abuts projects into the safety zone. In other words, the geometric comparison may comprise a mere determination of a presence of an overlap. In the described cases, a safe movement of the potential collision object in its safety zone may be impaired or spatially restricted by the current movement behavior of the vehicle.

Steps of the method may be carried out continuously. In other words, the steps may be carried out in a loop. If the vehicle and/or the potential collision object is in motion, the safety zone of the potential collision object may thus be continuously defined at different points in time and the trajectory corridor can be continuously predicted at these points in time. Continuously defined safety zones may be continuously compared with the continuously predicted trajectories.

Therefore, in an environment in which at least one vehicle and at least one object may be present, a safe movement space can be maintained for the at least one object, taking into account the movement behavior of the vehicle. A corridor covered by the vehicle in the future is predicted for this purpose. In the event that the object is spatially impaired or endangered by the vehicle, a measure is taken to resolve the impairment. In addition, a vehicle may be navigated in such a way that a future risk of collision with potential collision objects is constantly minimized.

In one embodiment of the method, the safety zone around the potential collision object is located within a detection region of an environment detection sensor system arranged on the vehicle. The environment detection sensor system may have at least one camera, at least one laser scanner (lidar), at least one radar sensor, and/or at least one ultrasonic sensor, whereby a potential collision object may be detected individually or in any combination. The at least one camera can, for example, detect a potential collision object in a stereo operation or a mono operation. The detection region may thus comprise a region around the vehicle as a function of a detection distance of the environment detection sensor system in which a potential collision object can be reliably detected by the environment detection sensor system.

In a further embodiment of the method, the step of defining the safety zone around the potential collision object is carried out while taking into account a shadowed region. The shadowed region may be a region which is within the detection region, which may be cast in shadow by the vehicle and cannot be detected by means of the environmental detection sensor system. A vehicle part which causes shadowing may be, for example, a trailer or a work tool of the vehicle. If the environment detection sensor system has at least two different sensors, which may be arranged at different positions on the vehicle, the environment detection sensor having the largest detection region and/or the smallest current shadowed region may be selected for detecting objects. Furthermore, as a function of the current position of a vehicle part, which may result in different shadowed regions for the different sensors, the sensor whose detection region is currently the least shadowed may be selected for environment detection. If the environment detection sensor system comprises at least two different sensors, which may be arranged at different positions on the vehicle, at least two sensors may also be consolidated. A consolidated detection region can thus be enlarged in comparison to a single detection region. Therefore, the safety zone may thus be enlarged and/or the shadowed region may be reduced.

As a further step, the method may comprise detecting a relative position of the potential collision object with respect to the vehicle with the environment detection sensor system. In one embodiment of the method, the step of defining the safety zone is then carried out while taking into account the relative position of the potential collision object around the potential collision object. The safety zone around the potential collision object may thus be defined in a region that does not completely surround the vehicle. Rather, the safety zone may be a region that is circumscribed around the potential collision object. For example, the safety zone may extend radially around the potential collision object. Alternatively or additionally, the safety zone may be a zone which is limited by a partial detection region of the environment detection sensor system. For example, based on the vehicle's environment detection sensor system, the safety zone may thus be sectorally limited by a detection angle region.

As one step, one embodiment of the method comprises a prediction of at least two trajectory corridors which can be covered by the vehicle along at least two future trajectories. The at least two future trajectories may be determined based on different future travel routes of the vehicle. The various future travel routes may have different route profiles that can be driven in the future. The at least two future trajectories may have, for example, a left turn or a cornering maneuver which curves left and a right turn or a cornering maneuver which curves right along a respective future route. One of the at least two future trajectories may, for example, also comprise straight-line travel or a straight route. Furthermore, the embodiment may comprise a selecting of one of the at least two predicted trajectory corridors based on a detected vehicle behavior or based on a vehicle operator behavior. The accurate or more probable future trajectory can be determined and selected based on such an operator behavior, for example a specification of a steering angle, an acceleration specification based on an accelerator pedal position or a brake pedal position or an actuation of a turn signal. The safety measure on the vehicle for avoiding the collision of the vehicle with the collision object can occur as a function of a geometric comparison of the selected trajectory corridor with the defined safety zone.

In a further embodiment of the method, the step of predicting the trajectory corridor or the at least two trajectory corridors is performed based on a sensor system arranged on the vehicle. The sensor system arranged on the vehicle can be embodied to determine a current trajectory of the vehicle. The sensor system may be a sensor system which determines the position and/or direction for determining the current position of the vehicle or a two-dimensional movement of the vehicle. Such a sensor system may, for example, have a steering angle sensor, a yaw rate sensor, an inertial measurement unit (IMU), a global navigation satellite system (GNSS), a wheel speed sensor, and/or a radar sensor for determining an overground speed. If the vehicle is an articulated-joint vehicle, the sensor system may also have an angle of articulation sensor. The sensor system arranged on the vehicle may alternatively or additionally be designed to determine a status parameter of a drive train of the vehicle. The status parameter may, for example, be a current engine speed, transmission ratio, or transmission output speed. In order to predict the trajectory corridor, a vehicle outline may be taken into account, wherein the vehicle outline may be a region horizontally circumscribed by the vehicle. The vehicle outline may change as a function of vehicle-specific kinematics or a turning behavior. A current vehicle outline can also be detected and/or modeled by measurement technology.

In a further embodiment of the method, an intervention in the lateral dynamics of the vehicle is carried out as a safety measure in order to avoid the collision of the vehicle with the collision object. Alternatively or additionally, an intervention in the longitudinal dynamics of the vehicle in order to avoid the collision of the vehicle with the collision object can be performed as a safety measure. The intervention in the lateral dynamics of the vehicle may, for example, comprise a change in a direction of travel or a change in a steering angle of the vehicle. In contrast, the intervention in the longitudinal dynamics of the vehicle may, for example, comprise a change in the driving speed of the vehicle. This may be an acceleration or deceleration of the vehicle. The braking may be a slowing down until the vehicle comes to a standstill. Alternatively or additionally, a transmission ratio may also be changed as a safety measure.

In a further embodiment of the method, a visual, acoustic, or haptic warning to an operator of the vehicle and/or of the collision object is performed as a safety measure in order to avoid the collision of the vehicle with the collision object. The operator of the vehicle may be a driver in the vehicle. Equally, the operator may control the vehicle remotely. The operator can subsequently select an alternative travel route to avoid the collision. A “bystander” outside the vehicle can also be warned. It is also conceivable for an operator of the vehicle to be warned by haptic feedback from the steering wheel, for example by shaking.

In a further embodiment of the method, the geometric comparison of the predicted or selected trajectory corridor with the defined safety zone comprises a determining of a distance between them. The safety measure can thus be initiated as a function of how close the vehicle will advance to the safety zone in the considered time period for the trajectory corridor. Furthermore, a limit value can be defined for a distance between the predicted or selected trajectory corridor and the defined safety zone. The limit value may be a safety distance between the trajectory corridor and the safety zone. The determined distance may be the smallest distance between the trajectory corridor and the defined safety zone. The step of performing the safety measure on the vehicle may further be executed in order to maintain or again increase a current distance between the trajectory corridor and the defined safety zone if the determined smallest distance falls below the defined limit value. The current distance can be increased again by the safety measure directly, for example by the selection of an alternative driving route, or indirectly, for example by a warning, as described above.

The present disclosure also relates to a control device configured to carry out the method according to one of the described embodiments. The control device may have various interfaces for receiving and outputting the corresponding signals. Within the scope of the disclosure, a device of the control device for executing a specific function can be understood to mean a specific customization, for example a programming, of the control device for executing the function. The present disclosure also relates to a vehicle having such a control device. The vehicle may be designed as a vehicle that can be operated away from the road network. The vehicle may also be designed as a vehicle that can be operated autonomously or as a driverless vehicle.

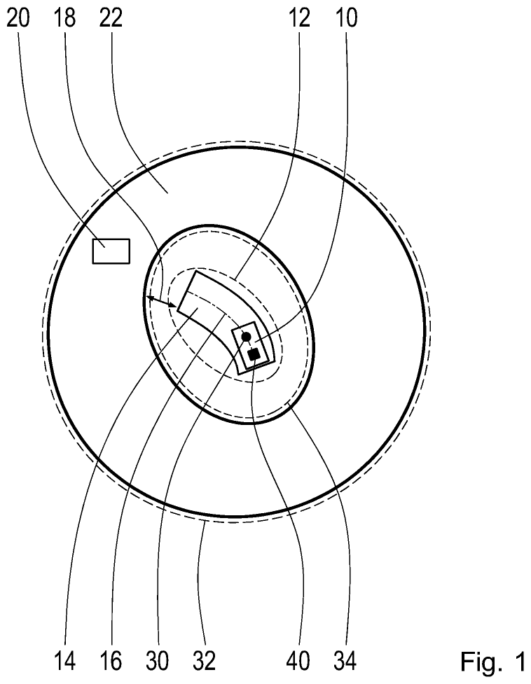

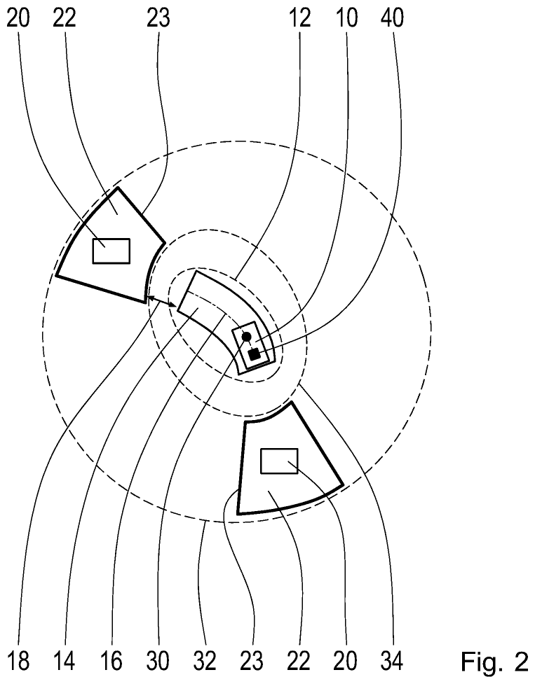

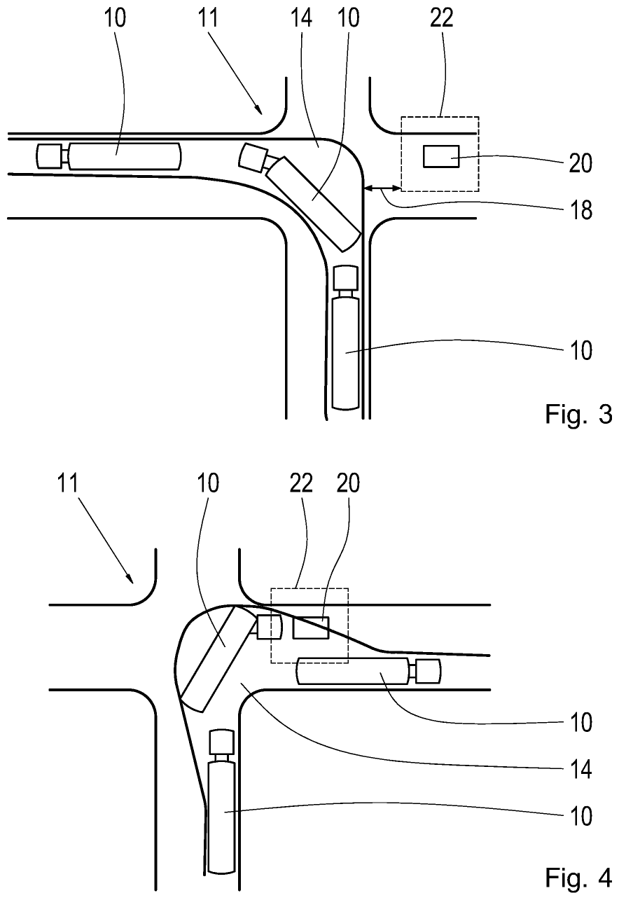

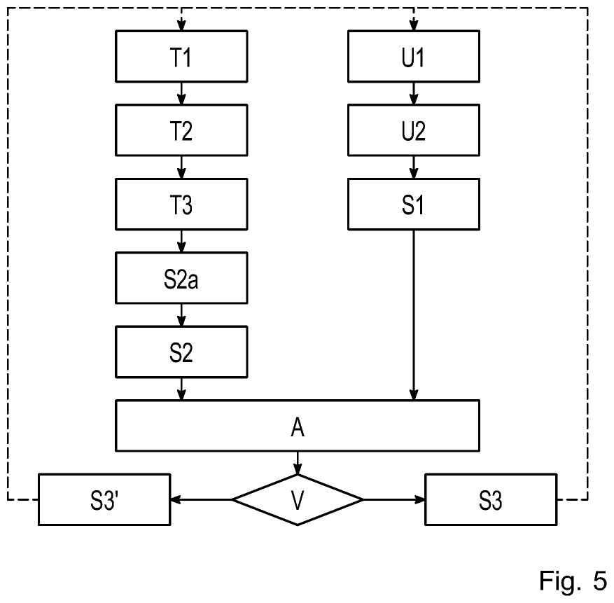

FIG. 1 shows a vehicle having a control device for explaining a method for collision avoidance. For this purpose, a ring-like safety zone is shown, which surrounds the potential collision object and encloses the vehicle. FIG. 2 shows the vehicle from FIG. 1 to further explain the method for collision avoidance. For this purpose, a safety zone is shown which surrounds the potential collision object at a distance from the vehicle. FIG. 3 shows another vehicle according to an embodiment to further explain the method for collision avoidance. A trajectory corridor of a truck when turning left is shown for this purpose. FIG. 4 shows the vehicle from FIG. 3 to further explain the method for collision avoidance. A trajectory corridor of a truck when turning right is shown for this purpose. FIG. 5 shows a diagram with steps of the method for avoiding collision of a vehicle with a potential collision object.

FIG. 1 shows a vehicle 10 having a control device 40 and a potential collision object 20 in the environment of the vehicle 10. In addition, various regions relevant to the method for avoiding a collision of the vehicle 10 with the potential collision object 20 are shown schematically, which will be discussed in more detail below.

A safety zone 22 around the potential collision object 20 is limited on the one hand by a detection region 32 of an environment detection sensor system 30 arranged on the vehicle 10. The detection region 32 thus represents an outer boundary of the safety zone 22. On the other hand, the safety zone 22 is limited by a shadowed region 34 of the environment detection sensor system 30 arranged on the vehicle 10. The shadowed region 34 thus represents an inner boundary of the safety zone 22. The environment detection sensor system 30 cannot detect a potential collision object 20 which is in the shadowed region 34. The safety zone 22 is also located outside a danger zone 12 around the vehicle 10, in which there is a direct risk by moving vehicle parts.

Starting from an already traveled trajectory (not shown) of the vehicle 10, a future trajectory 16 is predicted by means of extrapolation of the already traveled trajectory of the vehicle 10. The length of the future trajectory 16 is determined as a function of a journey time and a future vehicle speed. Taking into account vehicle kinematics and a vehicle contour along the future trajectory 16, a trajectory corridor 14 is then predicted, which the vehicle 10 covers along the future trajectory 16.

In order to assess a risk of collision between the vehicle 10 and the potential collision object 20, a distance 18 between the safety zone 22 and the predicted trajectory corridor 14 is calculated. If the distance 18 exceeds a safety distance (not shown) between the safety zone 22 and the predicted trajectory corridor 14, a collision is not to be expected. If the distance 18 falls below the safety distance between the safety zone 22 and the predicted trajectory corridor 14, the predicted trajectory corridor 14 touches the safety zone 22 or the predicted trajectory corridor 14 and the safety zone 22 overlap in an overlapping region (not shown). In this case, a collision can be expected.

The situation shown in FIG. 2 differs from the situation shown in FIG. 1 in that the safety zone 22 of a collision object 20 does not completely enclose the vehicle 10 as shown in FIG. 1. Instead, the safety zone 22 is embodied as a partial region of the ring-like region defined between the detection region 32 and the shadowed region 34. For further clarification, a further potential collision object 20 is shown. In addition to the detection region 32 as an outer boundary and the shadowed region 34 as an inner boundary, a border 23 of the safety zone 22 can thus also have lateral boundaries starting from the position of the potential collision object 20. The lateral boundaries are defined by a sectoral region in the detection region 32 in which the potential collision object 20 is located. The safety zone 22 then has two corresponding regions, with their borders 23, defined around the two potential collision objects 20. If only one potential collision object 20 is present in the vehicle environment, the safety zone 22 consists of only one region defined in this way.

A safety measure for avoiding a collision of the vehicle 10 with the collision object 20 then consists in a warning to an operator of the vehicle 10 or in the selection of an alternative trajectory deviating from the predicted trajectory 16. The alternative trajectory has a shorter length or another course in order to increase a distance between the safety zone 22 and a trajectory corridor of the alternative trajectory in comparison to the distance 18.

In FIGS. 3 and 4, the vehicle 10 is designed as a tractor trailer with a towing vehicle and a semi-trailer. The vehicle 10 turns at an intersection 11. In doing so, the vehicle 10 covers trajectory corridors 14 that differ as a function of a left turn shown in FIG. 3 or a right turn shown in FIG. 4, wherein the difference does not just exist in a symmetrical reflection but in the geometric shape. In addition, a potential collision object 20 is again shown in FIGS. 3 and 4. A safety zone 22 is schematically shown around the potential collision object 20, which safety zone 22 is formed according to the above explanations in connection with FIGS. 1 and 2.

In FIG. 3, a distance 18, which does not fall below a safety distance (not shown), exists between a trajectory corridor 14 when the vehicle 10 turns left and the safety zone 22 around the potential collision object 20 at a certain point in time. A safety measure for avoiding a collision between the vehicle 10 and the potential collision object 20 at the intersection 11 is thus not required in the situation shown while the vehicle 10 is driving. In FIG. 4, a trajectory corridor 14 when the vehicle 10 is turning right and the safety zone 22 around the potential collision object 20 overlap at a specific point in time. A safety measure for avoiding a collision between the vehicle 10 and the potential collision object 20 at the intersection 11 is thus required while the vehicle 10 is driving. In one example, this consists of a warning to the operator of the vehicle 10 even before the vehicle 10 has entered the intersection 11.

FIG. 5 shows a diagram with steps of a method for avoiding collision of a vehicle 10 with a potential collision object 20. In a first step U1, one or more potential collision objects 20 are detected with the environment detection sensor system 30 arranged on the vehicle 10, and the relative position of the potential collision object 20 relative to the vehicle 10 is determined. In so doing, the at least one potential collision object 20 is detected with a plurality of environment detection sensors. Based on the potential collision object 20 thus detected redundantly, the signals detected by the environment detection sensors are consolidated in a further step U2. Consolidating the detected signals comprises overlaying or selecting detection regions and shadowed regions of the environment detection sensors of the environment detection sensor system 30 in order to detect the potential collision object 20. Depending on steps U1, U2, the safety zone 22 around the at least one detected potential collision object 20 is determined in step S1, as described above.

In parallel to steps U1, U2, S1 for determining the safety zone 22, at least one sensor present on the vehicle 10 for detecting the vehicle kinematics is selected in a step T1. In a further step T2, the current vehicle kinematics are calculated based on selected signals from the at least one selected sensor. In a further step T3, at least one future vehicle trajectory 16 and at least one future trajectory corridor 14, as described above, are calculated as a function of vehicle kinematics. In a further subsequent step S2a, a trajectory corridor 14 is selected as a function of a driving situation or of a determined or predicted turning behavior, as shown in FIGS. 3 and 4. A single trajectory corridor 14 is predicted in step S2 based on the at least one future vehicle trajectory corridor 14 calculated and the selection of a calculated trajectory corridor 14.

Based on steps S1, S2, the minimum distance 18 between the safety zone 22 defined in step S1 and the trajectory corridor 14 predicted in step S2 is calculated in a further step A. In a distance comparison V as the next step, it is considered whether the calculated distance 18 is less than a permitted distance as a comparison threshold. If this is the case, one of the safety measures described above for avoiding a vehicle object collision is executed in step S3. If, in the case of the distance comparison V, it is determined that the calculated distance 18 is greater than or equal to the permitted safety distance, in the subsequent step S3′, none of the described safety measures for avoiding a vehicle object collision are performed. After step S3 or S3′, the described method steps are carried out again, starting with steps T1 and U1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

10 Vehicle
11 Intersection
12 Danger zone
14 Trajectory corridor
16 Future trajectory
18 Distance
20 Potential collision object
22 Safety zone
23 Safety zone border
30 Environment detection sensor system
32 Detection region
34 Shadowed region
40 Control device
A Distance calculation
S1 Safety zone definition
S2 Trajectory corridor prediction
S2a Trajectory corridor selection
S3 Safety measure implementation
S3′ No safety measure implementation
T1 Vehicle sensor system selection
T2 Vehicle kinematics calculation
T3 Trajectory calculation
U1 Collision object detection
U2 Consolidation
V Distance comparison

1. A method for avoiding a collision of a vehicle with a potential collision object, the method comprising:
defining a safety zone around the potential collision object, wherein the safety zone is located outside a danger zone around the vehicle,
predicting a trajectory corridor which is covered by the vehicle along a future trajectory and during a certain time period, and
performing a safety measure on the vehicle in order to avoid a collision of the vehicle with the potential collision object as a function of a geometric comparison of the predicted trajectory corridor with the defined safety zone.

2. The method according to claim 1, wherein the safety zone is located within a detection region of an environment detection sensor system arranged on the vehicle.

3. The method according to claim 2, wherein the step of defining the safety zone is carried out taking into account a shadowed region which represents a region which is cast in shadow by the vehicle and cannot be detected by the environment detection sensor system.

4. The method according to claim 2, further comprising:
detecting a relative position of the potential collision object with respect to the vehicle with the environment detection sensor system, wherein the step of defining the safety zone is carried out taking into account the detected relative position around the potential collision object.

5. The method according to claim 1, further comprising:
predicting a second trajectory corridor which can be covered by the vehicle along a second future trajectory, and
selecting one of the first and second trajectory corridors based on a detected vehicle behavior,
wherein the performing the safety measure on the vehicle in order to avoid the collision of the vehicle with the collision object is performed as a function of geometric comparison of the selected trajectory corridor with the defined safety zone.

6. The method according to claim 1, wherein the step of predicting is performed based on a sensor system arranged on the vehicle, the sensor system being designed to determine a current trajectory of the vehicle.

7. The method according to claim 1, wherein an intervention in the lateral dynamics and/or longitudinal dynamics of the vehicle in order to avoid the collision of the vehicle with the collision object is performed as a safety measure.

8. The method according to claim 1, wherein a visual, acoustic, and/or haptic warning to an operator of the vehicle and/or of the collision object is performed as a safety measure in order to avoid the collision of the vehicle with the collision object.

9. The method according to claim 1, wherein the geometric comparison of the trajectory corridor with the defined safety zone comprises, in the step of performing the safety measure, a determination of a distance between the trajectory corridor and the defined safety zone.

10. The method according to claim 9, further comprising:
defining a limit value for a distance between the trajectory corridor and the defined safety,
wherein the determination of the distance between the trajectory corridor and the defined safety zone comprises, in the step of performing the safety measure, a determination of a smallest distance between the trajectory corridor and the defined safety zone, and
wherein the step of performing the safety measure is executed on the vehicle in order to again increase a current distance between the trajectory corridor and the defined safety zone when the determined smallest distance between the trajectory corridor and the defined safety zone falls below the defined limit value.

11. A control device which is configured to carry out the method according to claim 1.

12. A vehicle designed to be operated away from the road network, the vehicle comprising:
the control device according to claim 11.
